(19) United States
(12) Patent Application Publication
(10) Pub. No.: US 2009/0116570 A1
(43) Pub. Date: May 7, 2009

(54) METHOD AND APPARATUS FOR GENERATING CHANNEL QUALITY INDICATOR, PRECODING MATRIX INDICATOR AND RANK INFORMATION

(75) Inventors: Erdem Bala, Farmingdale, NY (US); Kyle Jung-Lin Pan, Smithtown, NY (US); Afshin Haghighat, Ile-Bizard (CA); Donald M. Grieco, Manhasset, NY (US); Zinan Lin, Melville, NY (US); Robert L. Olesen, Huntington, NY (US); Guodong Zhang, Syosset, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/261,437

(22) Filed: Oct. 30, 2008

Related U.S. Application Data
(60) Provisional application No. 60/984,915, filed on Nov. 2, 2007.

(51) Int. Cl. H04L 27/28

(52) U.S. Cl. 375/260

(57) ABSTRACT

A method and apparatus for generating channel quality indicator (CQI), precoding matrix indicator (PMI) and rank information are disclosed. The method and apparatus reduces feedback overhead and defines differential CQI information in an orthogonal frequency division multiplex (OFDM) symbol.

### CROSS REFERENCE TO RELATED APPLICATION

This application claims the priority benefit of U.S. Provisional Application No. 60/984,915, filed on Nov. 2, 2007, which is incorporated by reference as if fully set.

### FIELD OF INVENTION

This application is related to wireless communication systems.

### BACKGROUND

The downlink transmission scheme for Long Term Evolution (LTE) is based on conventional orthogonal frequency division multiplexing (OFDM). In an OFDM system, the available spectrum is divided into multiple carriers, called sub-carriers, which are orthogonal to each other. In an LTE wireless communication network, downlink transmission is typically based on an orthogonal frequency division multiple access (OFDMA) technique. OFDMA allows multiple wireless transmit receive units (WTRUs) to share the same bandwidth. This is performed by assigning a subset of sub-carriers to different WTRUs, allowing multiple low data rate streams for different WTRUs at the same time. A number of sub-bands in an OFDM symbol are used by a Node B to transmit data to a number of WTRUs. The Node B needs to know the channel quality of the WTRUs and the preferred precoding matrices over a set of sub-bands to schedule transmissions to the WTRUs. The required information is computed and fed back to the Node B.

The Node B scheduler should have correct information about the downlink channel between the Node B to the WTRU in order for the LTE system to function efficiently.

### SUMMARY

A method and apparatus is disclosed for a WTRU to feedback a channel quality indicator (CQI), a precoding matrix indicator (PMI), and rank information to a Node B with reduced overhead. Also disclosed are a method and apparatus for signaling between the Node B and the WTRU to coordinate the feedback.

### BRIEF DESCRIPTION OF THE DRAWINGS

A more detailed understanding may be had from the following description, given by way of example and to be understood in conjunction with the accompanying drawings wherein:

FIGS. 1A and 1B show symbols having associated CQI values and denoting separate sub-bands in the frequency domain;

FIG. 2 shows reference points distributed in frequency;

FIG. 3 shows non-continuous sub-bands of a symbol and average CQI reference points;

FIG. 4 shows non-continuous sub-bands of a symbol divided into different groups and having reference points with associated full-resolution CQI values;

FIG. 5 shows non-continuous sub-bands of a symbol, forming a group of sub-bands;

FIG. 6 shows non-continuous sub-bands of a symbol having associated CQI values computed differentially and serving as anchor points;

FIGS. 7A and 7B show symbols denoting sub-bands having full-resolution CQI values and sub-bands without full-resolution CQI values which are computed differentially with respect to a plurality of reference points;

FIGS. 8A and 8B show a plurality symbols, each having reference points, and denoting sub-bands;

FIG. 9 shows a plurality of symbols having full-resolution wideband CQI values and CQI values computed differentially;

FIGS. 10A and 10B show a generalized bitmap approach used to compute differential CQI and a bitmap approach;

FIGS. 11A, 11B and 11C show a plurality of symbols denoting sub-bands having differential CQI values determined for a codeword with respect to another codeword;

FIGS. 12A, 12B, 12C and 12D shows a plurality of symbols having full-resolution wideband CQI values and CQI values computed differentially determined for two codewords;

FIGS. 13A and 13B show an adaptive quantization of CQI for the generalized bitmap approach;

FIGS. 14A and 14B show an adaptive quantization of CQI for the generalized bitmap approach, wherein N=2³=8 is one possible mapping;

FIG. 15 shows a time differential CQI;

FIG. 16 shows different groups for periodic CQI reporting;

FIG. 17 is a flow diagram of an exemplary procedure of adjusting and signaling PMI for a PUSCH;

FIG. 18 is a block diagram of a WTRU; and

FIG. 19 is a block diagram of a Node B.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node B, a site controller, an access point (AP), or any other type of interfacing device capable of operating in a wireless environment.

Methods to Define a Differential Channel Quality Indicator (CQI)

Disclosed herein are methods to define a differential CQI. The differential CQI is used to provide accurate information about the quality of channels, while reducing the feedback overhead of the CQI information. CQI is a measure of channel quality and is computed for a sub-band, where a sub-band is defined as a contiguous set of sub-bands in an OFDM symbol. In OFDM, the channel generally comprises a plurality of sub-bands, divided into a plurality of frequency bands, where each frequency band includes at least one-subcarrier. A CQI can be a single value that represents the channel quality for all of the sub-bands, or can be different for each sub-band. If it is a single value, then it may be referred to as an average or wideband CQI and denotes that the CQI computation is done in a frequency-nonselective manner, whereby, the different frequency characteristics of different sub-bands are ignored. Alternatively, the frequency selectivity of the channel may not be ignored and there may be a separate CQI value for a given portion of the frequency band, resulting in a more accurate representation of the channel.

More particularly, a method that reduces the feedback overhead of the CQI information is disclosed. The method includes techniques to determine a differential CQI wherein the differential CQI is a representation of a CQI value with respect to a reference value. The differential CQI is used to reduce the feedback overhead. The differential CQI may be represented with fewer bits whereas the reference value may be represented with full-resolution, that is, with the largest number of bits available.

Each CQI value is denoted with a number of bits. If there are N levels of CQI in a CQI table, (where N represents the total number of sub-bands), then the number of bits required to indicate each CQI entry is log₂N. For example, if a CQI table has 32 entries, then 5 bits are used. It should be understood that while the number of bits used in this example is 5 bits, any number may be considered, (e.g. 5, for the first codeword (CW), 3 for the second CW). For frequency selective CQI, the required number of bits to be transmitted to the Node B increases with the number of sub-bands. For example, if the CQIs of all sub-bands has full-resolution, that is, are represented by log₂N bits, then the total number of bits become Klog₂N where K denotes the number of sub-bands. On the other hand, representation of the wideband frequency non-selective CQI requires only log₂N bits.

The CQI can be fed back from the WTRU to the Node B either in the physical uplink control channel (PUCCH) or the uplink shared channel (PUSCH). As the frequency selective CQI requires more bits to be transmitted, the PUSCH is preferred to feedback this kind of CQI because the resources in the PUCCH are limited.

A set of sub-bands may be semi-statically configured by the Node B. The CQI is computed for all of these sub-bands and fed back to the Node B (full sub-band approach). The CQI may be an average value, (i.e., an average CQI for all of the configured sub-bands), or it could be a separate value for each sub-band. When the average CQI is computed for all of the sub-bands, this is called the wideband CQI.

The WTRU may select M sub-bands (where M represents the reference sub-bands with full resolution CQI), out of a set of sub-bands configured by the Node B and report the CQIs for the M sub-bands. The M sub-bands are usually the sub-bands with the largest CQI values (best-M approach). Similarly, the CQI can be an average value for the M sub-bands or it can be different for each of the M sub-bands. The WTRU also feeds back the indexes of the M sub-bands selected for reporting.

As an example, a full-resolution CQI value may be represented with 5 bits. Feeding back 5 bits for each of the sub-bands in the case of frequency selective CQI requires many resources. To reduce the feedback overhead, it is possible to represent the CQIs of some sub-bands with smaller resolution, that is, with fewer than 5 bits per sub-band. The CQI values are computed with respect to a given reference value and denote the differential between that reference point and the original CQI value.

As another example, let the reference value be wideband CQI. If there are six sub-bands, the wideband CQI for these six sub-bands is computed. The CQI of the sub-bands from 1 to 6 can be computed as CQI sub-band=CQI wideband+CQIΔ where CQIΔ is defined as the differential CQI. With n bits to represent the differential CQI, (where n represents the number of bits), there are 2n step sizes. For example, when n=1, then the differential CQI can be [x] or [y], where x and y are the step sizes, and the CQI sub-band=CQI wideband+x or CQI sub-band=CQI wideband+y. The step sizes do not have to be linear and can be selected unevenly.

Differential CQI with Respect to Different Reference Points

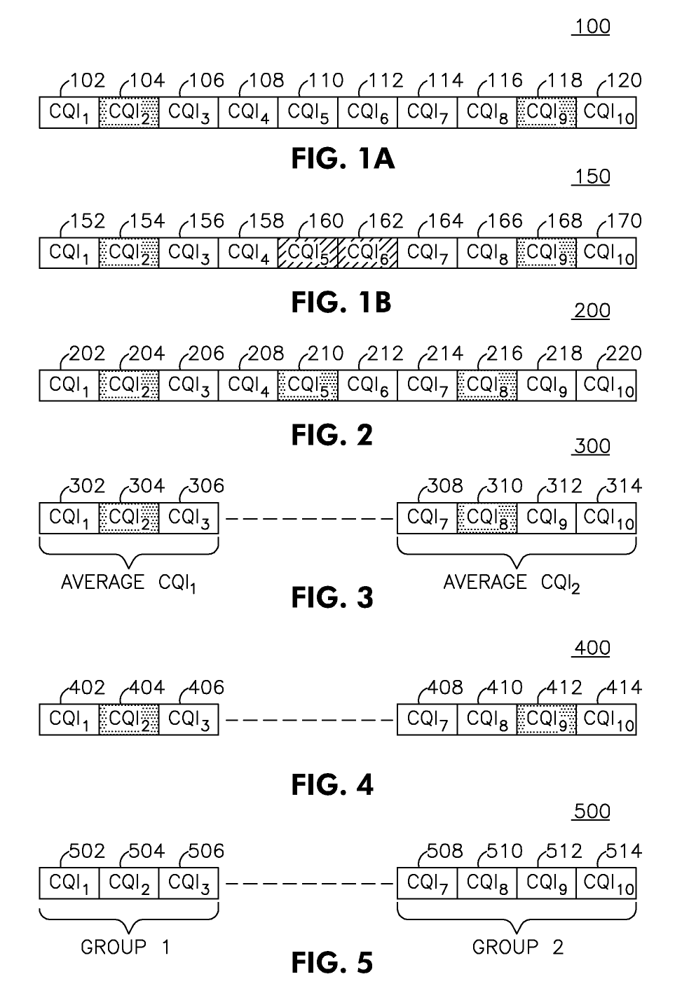

FIGS. 1A and 1B show symbols having associated CQI values and denoting separate sub-bands in the frequency domain. Referring to FIG. 1A, the OFDM symbol 100 comprises a plurality of sub-bands, 102,104,106,108,110,112,114,116,118 and 120, wherein differential CQIs may be computed with respect to a plurality of different reference points, CQI₂ and CQI₉. The reference points CQI₂ and CQI₉ can be in the same symbol 100 (frequency differential), or in the previous symbol (time differential). In the frequency differential method, instead of reporting the CQI value of each individual sub-band, the CQI values of each of the sub-bands in that symbol is compared against the reference CQI value found in the same OFDM symbol and the difference is evaluated and reported. In the time differential method, the CQI of the sub-band of a first symbol is compared against the CQI of the reference sub-band of a second OFDM symbol and the difference is evaluated and reported. If there are more than two codewords, (i.e. when the Node B uses multiple antennas to transmit two or more codewords), then the CQI of one codeword can be differentially computed with respect to another codeword. The methods in this section cover all of these aspects for differential CQI computation. Some of the CQIs in the sub-bands 104 and 118 may be used as reference points, (CQI₂ and CQI₉), with respect to which the CQIs of the other sub-bands 102, 106, 108, 110, 112, 114, 116 and 120 may be computed.

Still referring to FIG. 1A, the symbol 100 denotes separate sub-bands (102 to 120) in the frequency domain, and the corresponding CQI values for those sub-bands, 102 to 120 are denoted as CQI₁, CQI₂, and the like. The CQI of the neighboring sub-band may be used or a combination of the CQIs of several neighbors may be used as the reference point. For example, CQI₁ may be computed differentially with respect to the wideband CQI (CQI₁=CQI wideband+CQIΔ); CQI₂ can be computed differentially with respect to CQI₁ (CQI₂=CQI₁+CQIΔ); CQI₃ can be computed differentially with respect to CQI₂ (CQI₃=CQI₂+CQIΔ), and the like.

The accuracy of the CQI computation by using the neighbors as the reference can be improved if full-resolution CQIs are computed for some sub-bands, (such as with 5 bits), and used as reference points for the other sub-bands. For example, in FIG. 1A, the sub-bands denoted by shading 104, 118, comprise full-resolution CQI values. The CQIs of these full-resolution sub-bands 104, 118 are not differentially computed and they are represented with the highest CQI precision. The CQIs of the sub-bands denoted without shading 102, 106, 108, 110, 112, 114, 116 and 120 are differentially computed with respect to the sub-bands denoted with shading 104, 118. This could also be applied to the neighboring sub-bands, or a combination of those two.

For example, still referring to FIG. 1A, the CQI₁ and CQI₃ values may be computed differentially with respect to CQI₂, and CQI₈ and CQI₁₀ may be computed differentially with respect to CQI₉. CQI₄ may be computed differentially with respect to CQI₃, or a combination of CQIs such as CQI₂, and CQI₃, or any other possible combination.

To increase the accuracy of the sub-bands for which the full-resolution CQIs may not be a reliable reference point, different reference points, such as wideband CQI, could be used as reference for these sub-bands. For example, referring to FIG. 1B, the sub-bands denoted with crosshatch 160, 162, use the wideband CQI as the reference point. These sub-bands 160 and 162, are located far away from the full-resolution CQI reference points (denoted with shading) CQI₂, CQI₉ so the wideband CQI of the sub-bands 160 and 162 may be a more reliable reference point.

FIG. 2 shows reference points distributed in frequency. Sub-bands 204, 210 and 216 are selected as the reference sub-bands for CQI reporting. As a result, instead of reporting the exact CQI values of other sub-bands, only their differences against these reference points are reported. Sub-bands, 202 to 220, are divided into different groups and different reference points are used in different groups CQI₂, CQI₅ and CQI₈. Note that the sub-bands may be a continuous set or a non-continuous set as shown in FIG. 3. If the sub-bands for which the CQI is computed with full-resolution 204, 210 and 216 are distributed evenly in the frequency domain, then the other sub-bands that are closest to these sub-bands 202, 206, 208, 212, 218 and 220 may use the full-resolution sub-bands 204, 210 and 216 as the reference point. For example, CQI₄ and CQI₆ can be computed differentially with respect to CQI₅, CQI₇ and CQI₉ can be computed differentially with respect to CQI₈, and the like.

FIG. 3 shows non-continuous sub-bands 302, 304, 306, 308, 310, 312 and 314 of a symbol 300 and average CQI reference points, average CQI₁ and average CQI₂. In the extreme case, as shown in the symbol 300 when all of the sub-bands are non-continuous as previously disclosed, a common reference point such as the wideband CQI, or the maximum CQI may be used. However, another method that may be used when the sub-bands are non-continuous is to divide the sub-bands into several groups. In each group, one or more reference points are given and the CQIs for the sub-bands in a group are differentially computed with respect to the corresponding reference points. The reference points in a group may be: wideband CQI, the average CQI in that group, the maximum CQI in that group, the full-resolution CQIs in that group, etc.

For example, the sub-bands having the CQI values CQI₁, CQI₂, and CQI₃ in FIG. 3, may be computed differentially with respect to Average CQI₁ of the first group, and the sub-bands having the CQI values CQI₇, CQI₈, CQI₉, and CQI₁₀ may be computed differentially with respect to the average CQI₂ of the second group. A group of sub-bands, 302, 304 and 306 may be selected, for example, based on the maximum distance between the indexes of any two sub-bands in a group. This indicates that, in a group of sub-bands, 302, 304 and 306, not all of the sub-bands need to be contiguous. When the average CQI of a group of sub-bands is used as a reference, the average needs to be fed back as well. The overhead, then, is m times more than the case when only one wideband average of all of the sub-bands is fedback, where m is the number of groups. The overhead may be reduced by encoding the average CQIs of the groups, (Average CQI₁ and Average CQI₂), differentially.

FIG. 4 shows non-continuous sub-bands 402, 404, 406, 408, 410, 412 and 414 of a symbol 400 divided into different groups 402, 404, 406 and 408, 410, 412, 414, and having reference points CQI₂ and CQI₉ with associated full-resolution CQI values.

As illustrated in FIG. 4, reference points with full-resolution CQI, (CQI₂ and CQI₉), may also be used in each of these non-continuous sub-band groups 402, 404, 406, 408, 412 and 414 for computing differential CQI values.

FIG. 5 shows non-continuous sub-bands 502, 504, 506, 508, 510, 512 and 514, of a symbol 500, forming groups of sub-bands, group 1 and group 2.

One method to reduce the signaling overhead is to set up some rules regarding the definition of group. As an example, in FIG. 5 a group of sub-bands (group 1 and group 2) may be defined based on the maximum distance between the indexes of any two sub-bands 504 and 506 in a group. It can be assumed that if the difference between the indexes of the sub-bands, 504 and 506, is below a given number, then these sub-bands form a group, (group 1). Still referring to FIG. 5, the maximum difference between the indexes of the sub-bands 508 and 514 in group 2, (CQI index CQI₁₀ and CQI₇), is 10−7=3. The definition of the groups starts from the sub-band with the lowest index CQI₁, and adds suitable sub-bands, until there are no sub-bands suitable for the first group 1. Then, the second group (group 2) is started and the next sub-band 508, (CQI index CQI₇), is added into the second group, and so on, until all sub-bands are in a group, group 1 or group 2. Because the rules are known to the Node B and the WTRU, there is no need to signal the groups. This rule increases the likelihood that the sub-bands (502, 504, 506) in a group, (group 1), are correlated and the differential CQI has enough accuracy.

Once the groups (group 1, group 2), are formed, then the reference points similar as described in previous sections to reduce signaling overhead may be employed. For example, the first sub-band 502 in group 1 may be the reference for the other sub-bands 504,506 in group 1, and this first sub-band, 502₁, can be denoted with the full-resolution CQI. Alternatively, the average CQI in a group (group 1) may be used as the reference point in that group (group 1). It is possible to define different reference points. The reference points may be pre-defined arbitrary based on the maximum, mean, etc.

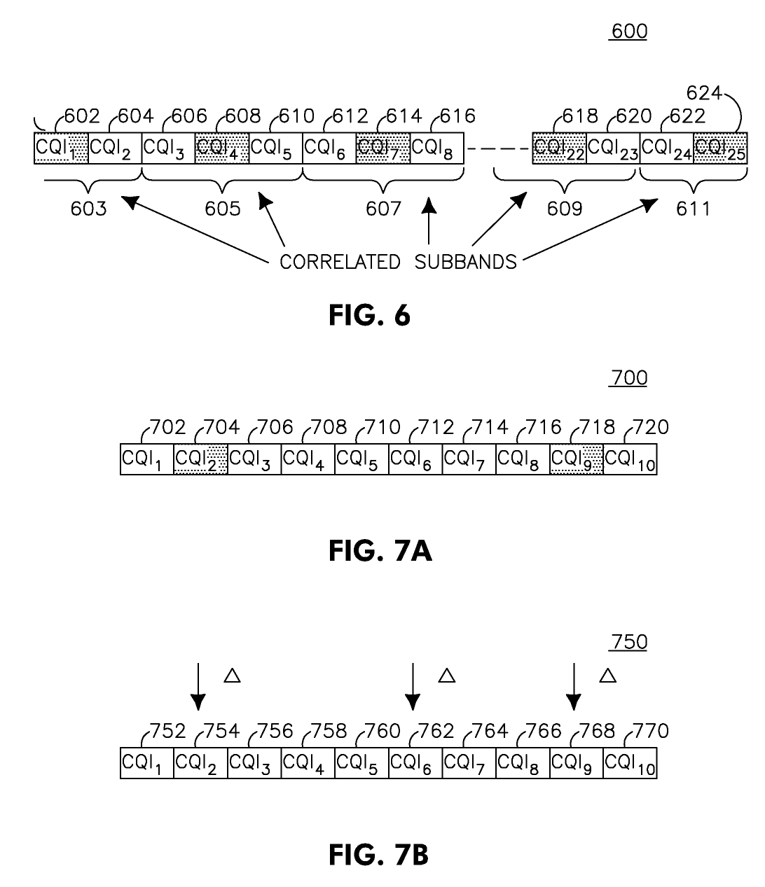

FIG. 6 shows non-continuous sub-bands 602 to 624 of a symbol, 600 having associated CQI values computed differentially and serving as anchor points 603,605,607,609,611. As shown in FIG. 6, differential CQIs (such as CQI₁, CQI₂) of sub-bands 602 and 604, can be computed differentially and used as anchor points 603, 605, 607, 609 and 611, for other correlated sub-bands, such as 606, 608, 610. Instead of sending equal bit words for differential CQI information of each sub-band, variable length words can be sent. Initially, some sub-bands 602 and 604, are identified as anchor points 603. These anchor points 603 will have the highest resolution for the differential CQI value. The remaining sub-band 606 is known as an adjacent sub-band. The difference between the reference point value (CQI₁) and the anchor point 603 is that reference points have full-resolution CQI, (for example 5 bits), but anchor points do not.

For the adjacent sub-band 606, the differential information is measured with respect to the closest anchor point 603. Therefore, a lower resolution (lower number of bits) can be used for the adjacent sub-bands.

Still referring to FIG. 6, if M, (where M is the number of reference sub-bands with full resolution CQI), and N, (where N represents the total number of sub-bands), and where (M>N) bits are considered for the differential information of anchor point 603 and adjacent sub-band 606, respectively, then, the total number of bits required for the report of this example will be NTotal=5 (for the wideband CQI)+9M (for the anchor points 9)+16N (for the adjacent sub-bands). If M=3 and N=1, NTotal=48 bits. If M=2 and N=1, NTotal=39 bits.

In this case, the CQIs of the anchor points 603, 605, 607, 609 and 611, are computed with respect to a reference point, for example the wideband CQI. It is also possible to have full-resolution CQIs, (CQI₁, CQI₄, and CQI₇), for some sub-bands and use them as reference for the anchor points 603, 605, 607, 609 and 611. It is also possible to use the techniques described in the previous sections with anchor points.

Several combinations of the schemes described above are possible. The reference or anchor points 603, 605,607, 609 and 611, that compute the differential CQIs, are configured to improve the performance and they may be different for different sub-bands. If configuration is not possible, then a fixed set of rules are used so that signaling overhead can be reduced.

Still referring to FIG. 6, the differential CQIs can be computed with respect to the wideband CQI, the maximum CQI, the CQI(s) of the neighbor sub-band(s), differential CQIs with larger resolution (anchor points), CQIs defined after a sorting operation, average CQI in a group of sub-bands, or a combination of these. The CQIs of some sub-bands CQI₁, CQI₄, can be transmitted with full resolution and can be used as reference points. Differential CQI step size can be optimized with statistical analysis for different channels. With more than 1 bit, there are (non-linear) CQI step sizes.

Methods similar to those set forth above can also be used to compute a differential CQI in the time domain. When the time domain is available, while computing the differential CQI of a sub-band, reference points from the same symbol (frequency domain), or reference points from previous symbols (time domain), or a combination of these can be used.

FIGS. 7A and 7B show symbols 700 and 750 denoting sub-bands 702 to 720 and 752 to 770, respectively, having full-resolution CQI values, (CQI₂, CQI₉), and sub-bands without full-resolution CQI, (CQI₁, CQI₆,), values which are computed differentially with respect to a plurality of reference points

As illustrated in FIG. 7A, in the first time instant, reference sub-bands, 704 and 718, with full-resolution CQIs, (CQI₂, CQI₉), are denoted with shading. The CQIs for the rest of the sub-bands, 702,706,708,710, 712, 714, 716, 718 and 720, are computed differentially with respect to the reference points, CQI₂ or CQI₉. As illustrated in FIG. 7B, all of the sub-bands, 752 to 770, of the second symbol 750, are computed differentially with respect to the same sub-bands in the previous symbol 700. It is also possible to use the reference points in the first symbol 700 as reference points in the second symbol 750 for some or all of the sub-bands. For example, CQI values 8, 9 and 10 my be computed differentially with respect to CQI values 8, 9, and 10 respectively in the previous symbol 700 or with respect to CQI₉ in the previous frame 750 or a combination of these.

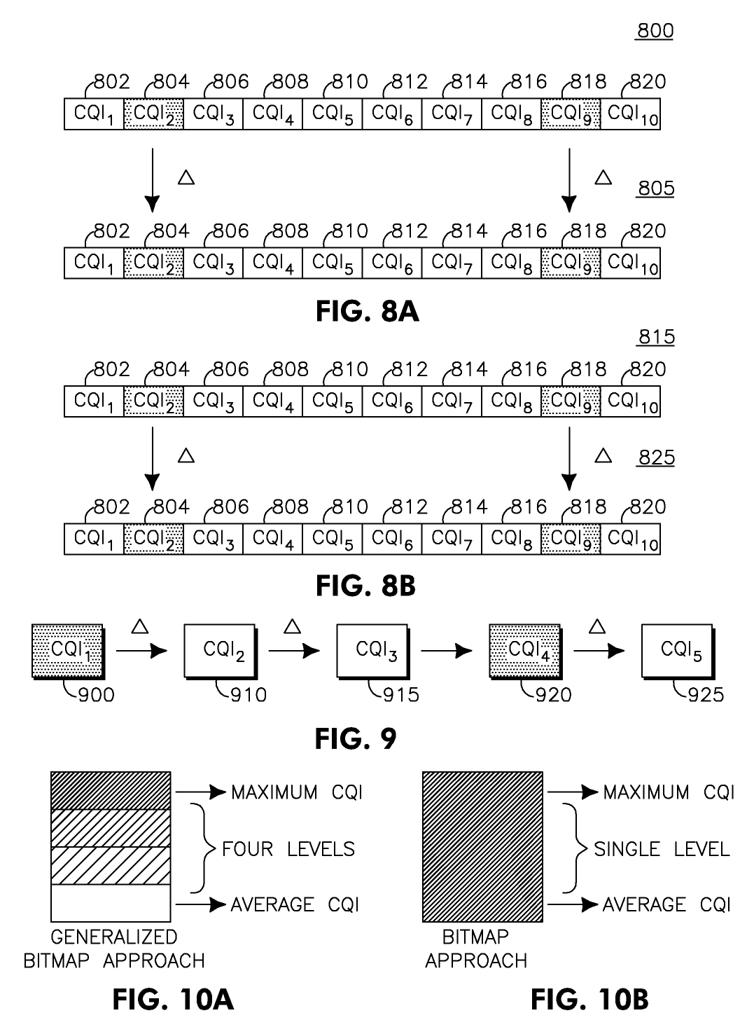

FIGS. 8A and 8B show a plurality symbols, 800, 805, 815, and 825 each having reference points, and denoting sub-bands 802 to 820. The accuracy of the time differential method can be increased by having reference points in each symbol. Two such cases are illustrated in FIGS. 8A and 8B.

As it can be seen in FIG. 8A, the reference points CQI₂, CQI₉, remain the same from one sub-frame 800 to the next sub-frame 805, whereas in FIG. 8B the reference points CQI₂ and CQI₉ hop in frequency from one sub-frame 815 to the next sub-frame 825. The hopping pattern may be configured by the Node B. When the reference points CQI₂ and CQI₉ hop, the quantization error is equalized among the sub-bands. For example, the CQI of the second sub-band 804 in the symbol 815 may be differentially computed with respect to the sub-band 806 on the symbol 815 and the sub-band 804 in the previous symbol 805. The reference point for the second sub-band 804 in the second symbol 805 may be, for example, the average of CQI₂ in the previous symbol 800 and CQI₃ in the symbol 815. The configuration of the reference points to compute differential CQIs has to be decided in either the frequency and/or time domain. It is possible to have different number of reference points in different symbols. It is also possible to have anchor points and/or reference points in a given symbol. For example, in FIG. 8A, the reference points CQI₂, CQI₉, in the second symbol 805 can be represented with a smaller resolution than full-resolution, i.e., like an anchor point, and the other sub-bands CQI₃ and CQI₁₀, in the same symbol 805 may use these anchor points as a reference.

FIG. 9 shows a plurality of symbols 900, 910, 915, 920 and 925 having full-resolution wideband CQI values, (CQI₁ and CQI₄), and CQI values computed differentially (CQI₂, CQI₃, CQI₅). If the feedback resources are limited, then it may be necessary to feedback the wideband CQI only. In this case, the wideband CQI is represented differentially to reduce the signaling overhead. For example, the full-resolution wideband CQI is sent at predetermined symbols 900, 910, 915, 920 and 925. In order to prevent error accumulation, differential CQI−CQI₁, CQI₄ is sent in between. Still referring to FIG. 9, the CQIs denoted with shading are full-resolution wideband CQI values. The CQIs denoted without shading are differentially computed with respect to the full-resolution wideband CQI (CQI₁ and CQI₄), the previous CQI value(s), or a combination of these. It is also possible to use a scheme with a decreasing/increasing resolution for CQIs in consecutive symbols. As an example, CQI₂ may be represented with a higher/lower resolution than CQI₃.

Generalized Bitmap Approach to Compute the Differential CQI

FIGS. 10A and 10B show a generalized bitmap approach used to compute the differential CQI, (FIG. 10A) and a bitmap approach (FIG. 10B). In FIG. 10A, the wideband CQI is computed for all of the given sub-bands. Then, for each sub-band, 1 bit is used to indicate if the CQI of that sub-band is above or below the wideband CQI. The wideband CQI and the bitmap, (1 bit indicators for the sub-bands), are fed back to the Node B. If the CQI of a sub-band is above wideband CQI, then the Node B assumes that the CQI of that sub-band is equal to the wideband CQI. If the CQI of a sub-band is below the wideband CQI, then the Node B assumes that the CQI of that sub-band is equal to the wideband CQI reduced by a given constant, i.e., CQI wideband-x, where x is a constant. To further reduce the overhead, the wideband CQI and the bitmap for the sub-bands are computed for odd and even numbered sub-bands in consecutive reporting periods. In the first time instance, the wideband CQI is sent for the odd (even) numbered sub-bands and 1 bit to indicate if the CQI of a sub-band is larger or smaller than the wideband CQI. In the second time instance, the same operation is completed for the even (odd) numbered sub-bands.

In FIG. 10A, the generalized bitmap approach is illustrated herein with 2 bits and only CQI values larger than the average CQI. In the PUSCH, where there are more resources, the accuracy of the bitmap approach can be increased by using more bits. The generalized bitmap approach is preferable to the bitmap approach, since the generalized bitmap approach has a rough representation of the CQI, and it works well for reporting CQI in the PUCCH. Accordingly, the CQI report may be transmitted in only a few symbols thus reducing the reporting delay. As illustrated in FIG. 10 A, instead of having only two levels of CQI accuracy (CQI is either larger or smaller than the wideband CQI), there are more levels.

CQI values smaller than the average CQI may be denoted by using another bit to indicate the sign. This increases the feedback overhead to 3 bits for the above example. In fact, indicating the sign with an additional bit is not necessary, and thus overhead is reduced. The bit combination 00 may be used to denote all CQIs smaller than the average CQI. The remaining three bit combinations 01, 10, and 11 may then be used to denote three levels of CQIs that are larger than the average CQI. The Node B always tries to use the best sub-bands, so reduction in the CQI accuracy of “bad” sub-bands, (those smaller than the average), will not result in much performance degradation. As a generalization, if there are n bits available, (where n is the number of bits), for the representing the CQI of a each sub-band, then there are 2n−x levels (where x is a variable) that are above the wideband CQI and x levels below the wideband CQI. (If x is 1, then 2n−1 levels are used for representing the CQI values above the wideband CQI. This method is also applicable to the differential CQI methods described in the previous sections.

Instead of using a fixed step size as disclosed above, the WTRU implicitly may use a dynamic step size for the CQI levels. For example, when x=1, the step size is equal to (CQI maximum−CQI average)/(2# of bits−1) for the CQI values above wideband CQI and where there is only one level for the CQI values below the wideband. The UE feeds back the wideband CQI and the generalized bitmap to the Node B. The maximum CQI is not fed back to the Node B. The feedback is the maximum value in the CQI table (the global maximum CQI).

The bitmap of all sub-bands (even and odd) can be reported at a given reporting instance. In a different embodiment the sub-bands are divided into groups (for example even and odd) and feedback the report for each group at different reporting times.

When the average CQI for a WTRU is low, for example if that WTRU is near the cell-edge, then most of the CQI values reported by that WTRU will be on the first interval above the average CQI because the global maximum CQI, (the largest CQI entry in the CQI table) is too large for the WTRU. If the Node B knows the maximum CQI the cell-edge WTRU may support, then the CQI report may have a better accuracy. Therefore, the Node B may use an adaptation algorithm (for example, by using the number of retransmissions etc) to come up with different maximum supportable CQIs for different groups of WTRUs, (cell center and cell edge). As another option, the maximum supportable CQI may also be fed back to the Node B by the WTRU in expense of increased feedback overhead. The wideband and maximum CQIs may be differentially encoded with respect to each other to reduce the feedback overhead. As an example, the wideband (maximum) CQI may be sent with 5 bits, and use 3 or 4 bits to represent the maximum (wideband) CQI with respect to the wideband (or maximum) CQI. The thresholds for the different levels of CQIs may be found by statistically analyzing different channel conditions resulting in uneven quantization levels. In this case, the generalized bitmap approach becomes similar to the methods described above.

A mapping method between the exact CQI value for a sub-band used by the Node B and the level that sub-band's CQI is also disclosed. As an example, if the CQI of a sub-band is in the interval [5, 10] and is above the wideband CQI, the Node B may use 5 as the CQI of that sub-band, as in the original bitmap approach. Alternatively, the Node B may use any other value that is between 5 and 10.

Overhead Analysis of Several Methods

The signaling overhead of some of the methods set forth above may be analyzed. The parameters are defined as follows:

m=number of bits for full-resolution CQI;

M=number of reference sub-bands with full-resolution CQI;

d1=number of bits for differential CQI with respect to the reference sub-bands;

k number of bits for the CQI of anchor pints;

K number of anchor points;

d2=number of bits for differential CQI with respect to the anchor points;

d3=number of bits to represent the differential CQI in the generalized bitmap approach; and

N=total number of sub-bands.

With the above parameters, the overhead of the three methods can be written as follows:

the overhead of the method shown in FIG. 2 is calculated as follows:

Mm+(N−M)d1; Equation (1)

the overhead of the method as shown in FIG. 6 is calculated as follows:

Kk+(N−K)d2+m; and Equation (2)

the overhead of the method as shown in FIG. 10 is calculated as follows:

Nd3+m. Equation (3)

Differential CQI for More than One Codeword

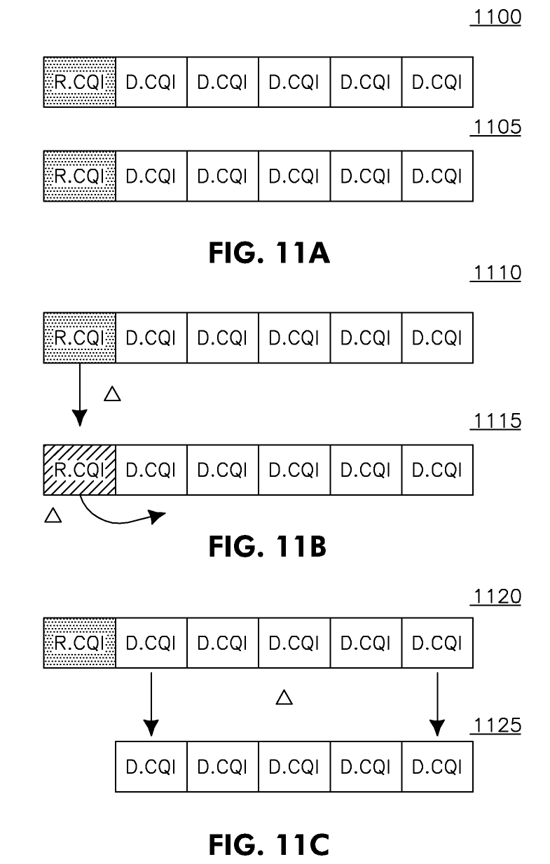

FIGS. 11A, 11B and 11C show a set of reported sub-band CQIs 1100, 1105, 1110, 1115, 1120 and 1125 denoting sub-bands having differential CQI values determined for a codeword with respect to another codeword. For example, the 6 blocks of the first row 1100 in FIG. 11A represent CQIs of the first codeword and the 6 blocks of the second row 1105 in FIG. 11A represent CQIs of the second codeword. FIGS. 11A, 11B and 11C show sub-bands 1100, 1105, 1110, 1115, 1120 and 1125 for which the reference and differential CQI is determined for a codeword with respect to another codeword. When more than one CQI value has to be fed back to the Node B, then some CQIs may also be differentially computed with respect to one or more of the other CQIs.

Still referring to FIGS. 11A, 11B and 11C, a differential CQI for two codewords 1100 and 1105 is shown. “R.CQI” represents reference CQI and “D.CQI” represents differential CQI. Note that in this figure the actual locations of the sub-bands are not illustrated. There are two differential CQI values, each for one codeword, or data stream. One reference CQI is assigned to the first codeword, and the differential CQI is defined for the first and second codewords. The CQI of the first codeword, which is determined by the Node B, (and is typically the one with a higher quality of service (QoS) which supports a higher bit rate of the two codewords), is reported using methods described in this disclosure. The second CQI value can be represented differently as illustrated in FIGS. 11A, 11B and 11C.

Still referring to FIGS. 11A, 11B and 11C, the CQI values denoted above are for the first codeword and the ones below are for the second codeword. In FIG. 11A, the differential CQIs are computed with respect to a given reference point for the first codeword. “R. CQI” represents reference CQI and “D. CQI” represents differential CQI. Note that, in FIG. 11A, the actual locations of the sub-bands are not illustrated because the sub-bands are representations of the allocations in frequency tones or carriers. Rather, FIG. 11A is an abstraction and the sub-bands for which the reference and differential computed CQIs may be distributed in the frequency band as shown in the previous sections.

In FIG. 11B, the reference CQIs of the second codeword are computed with respect to the reference CQIs of the first codeword. In this case, the reference CQIs of the second codeword, (denoted with shading), would not have full-resolution. Furthermore, the CQIs of the second codeword can be differentially computed with respect to the reference of the second codeword. Another option is not to have any reference point in the second codeword and use the CQI values of the first codeword as reference in the second codeword. The reference and differential CQIs of the first codeword can be used as references in this case. For example, the CQI of each sub-band for the second codeword can use the CQI of the same sub-band in the first codeword.

The same methods can similarly be applied when reporting a wideband CQI value or average CQI values for different groups of sub-bands. Then, the CQI of second codeword can again be differentially computed with respect to the CQI of the first codeword.

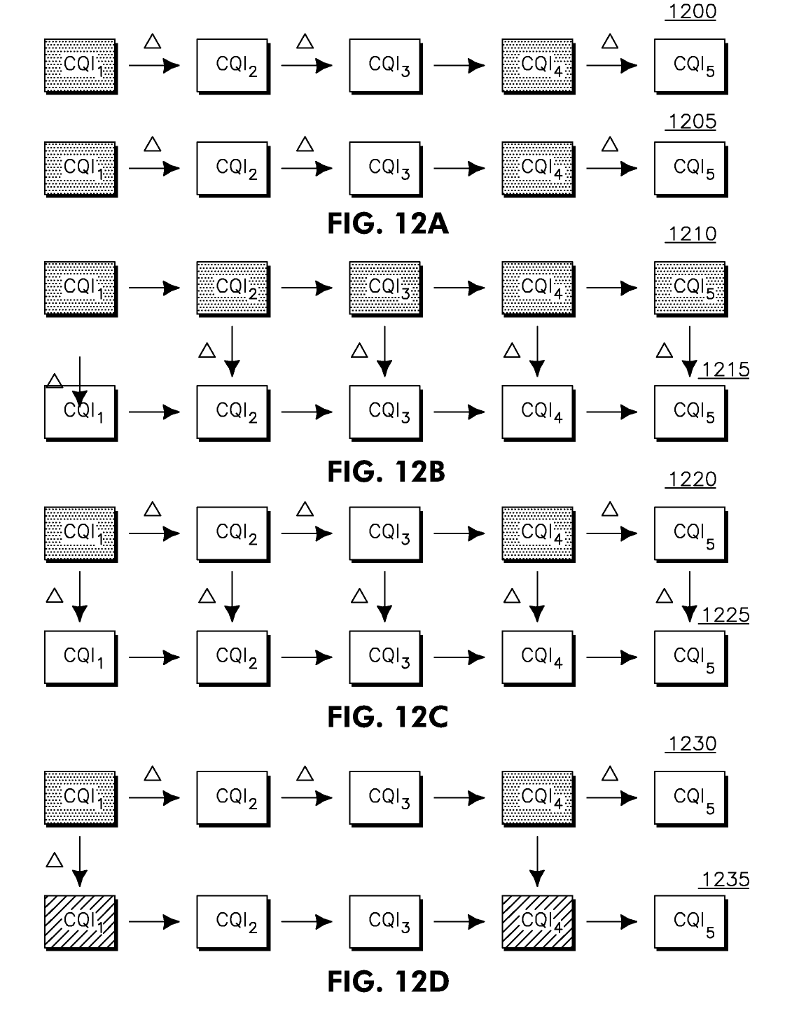

FIGS. 12A, 12B, 12C and 12D show a plurality of symbols 1200, 1205, 1210, 1215, 1220, 1225, 1230 and 1235, having full-resolution wideband CQI values and CQI values computed differentially determined for two codewords. In each of FIGS. 12A, 12B, 12 C and 12D, it should be noted that the first codeword is the first row of CQI values, and the second codeword is the second row of CQI values.

Referring to FIG. 12A, the CQIs of the two codewords may be independently computed.

Referring to FIGS. 12B and 12C, the CQIs of the second codeword may be differentially computed with respect to the CQI of the first codeword. Alternatively, the reference point for the second codeword may be differentially computed with respect to the reference point of the first codeword, (illustrated with shaded grey in FIG. 12C), and the next CQI values for the second codeword may be computed differentially with respect to this reference point (or the previous CQI value(s) or a combination of both).

Adaptive Quantization for Differential CQI

For differential CQI reporting, it is important to use the available number of quantization bits efficiently. Due to unpredictability of the channel, linear quantization is often used across the CQI range that is not efficient. Therefore, nonlinear quantization and adaptive step size for the quantization can be used to improve the accuracy and the efficiency of the quantization process.

A method and apparatus for a WTRU to feedback an adaptive referencing is disclosed. In this method, different number of levels for the differential CQI is used depending on the magnitude of the wideband CQI. When a wideband CQI is above a threshold, more levels are allocated to the sub-bands below the wideband CQI. When the wideband CQI is below a threshold, more levels are allocated to the sub-bands above the wideband CQI.

At high/low signal-to-noise ratios, it is not optimum to have equal coverage for high and low end of the CQI range for the quantization. For example, if the CQIwideband>ηHigh, where CQIwideband is the wideband CQI and ηHigh is a predetermined threshold, this indicates that the overall channel quality is good. In such situation, from the scheduler perspective, it is more important to know which sub-bands are in fade or in a less favorable condition and how low their CQIs are than knowing the accurate CQIs of the best sub-bands. The scheduler will distinguish the majority good sub-bands from the few degraded sub-bands, thereby avoiding over estimation of their CQI and MCS, and selecting the proper bands to reduce the number of unsuccessful transmissions. Conversely, when CQIwideband<ηLow, where ηLow is a predetermined threshold, the overall channel quality is worse and it would be more advantageous for the scheduler to have higher resolution CQI information about the sub-bands above the average.

The method starts with measuring the CQI_{wideband}·Q bits for quantization is assumed providing N=2^{Q} different levels. N is defined as N=N_{High}+N_{Low} where N_{High} and N_{Low} are the number of quantization levels used for the CQI range above and below the CQI_{wideband}.

If the CQI_{wideband}>η_{High}, then the quantization process is coded and decoded in such a way that a higher number of levels are considered for the region CQI<CQI_{wideband}.

If the CQI_{wideband}<η_{Low}, then the quantization process is coded and decoded in such a way that a higher number of levels are considered for the region CQI>CQI_{wideband}.

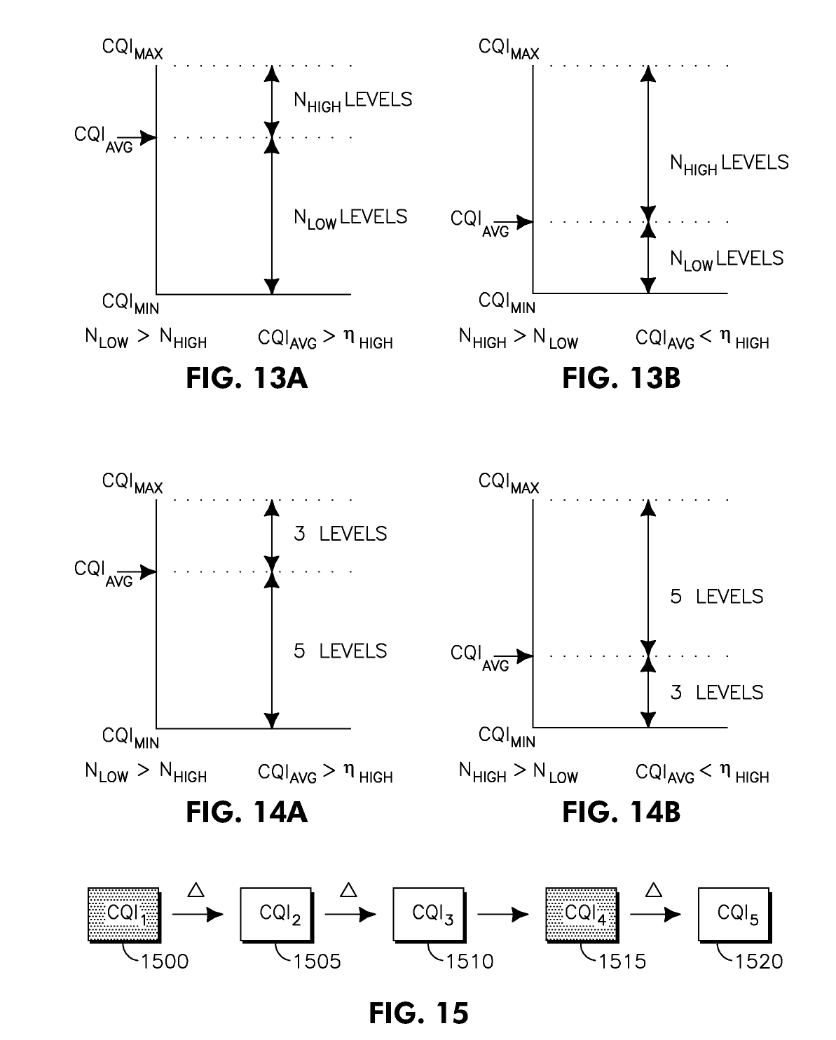

FIGS. 13A and 13B show an adaptive quantization of CQI for the generalized bitmap approach. When the thresholds η_{High} and η_{Low} are the same and equal to the wideband CQI, this solution becomes the same as the generalized bitmap approach. By having the two predetermined thresholds, a more accurate representation of the CQIs of the sub-bands may be achieved.

FIGS. 14A and 14B show an adaptive quantization of CQI for the generalized bitmap approach, wherein N=2³=8 is one possible mapping. It should be noted that it is also possible to have uneven quantization levels. It should also be noted that there is no restriction in the selection of N_{High} and N_{Low}. When the average CQI is above η_{High}, and only a few sub-bands need to be scheduled for the WTRU, then it may be more beneficial to have a better resolution for the sub-bands who's CQIs are above the average; then N_{High} can be larger than N_{Low}.

Grouping of Sub-Bands for Periodic Reporting

CQI reporting may be either periodic or a periodic. The periodic reporting is done in the PUCCH, but the techniques outlined above are also valid for the periodic reporting on the PUSCH if the number of available bits in the PUSCH is limited.

In PUCCH, the number of bits available is limited in a symbol, therefore it is not preferable to send frequency selective CQI information. The wideband CQI information may only be sent on this channel, and the time differential approach may be used in this case. In addition, the sub-bands may be divided into several groups, and the CQI may be computed for each group to improve the relative CQI accuracy. The signaling overhead may be reduced by applying a time differential CQI technique as illustrated in FIG. 9.

FIG. 15 shows a time differential CQI. The CQI values denoted with shading are the full-resolution wideband CQIs, and the CQI values denoted with no shading are differentially computed.

The CQI accuracy can be increased by dividing the sub-bands into different groups 1500, 1505, 1510, 1515 and 1520, and feeding back the average CQI information for a group at a given time instant instead of sending the wideband CQI for all sub-bands. Referring to FIG. 15, it should be noted that, there are no individual sub-bands. The groups 1500, 1505, 1510, 1515 and 1520 represent the equivalent CQI values of all the sub-bands (wideband CQI) over time or the equivalent CQI values of a group of sub-bands.

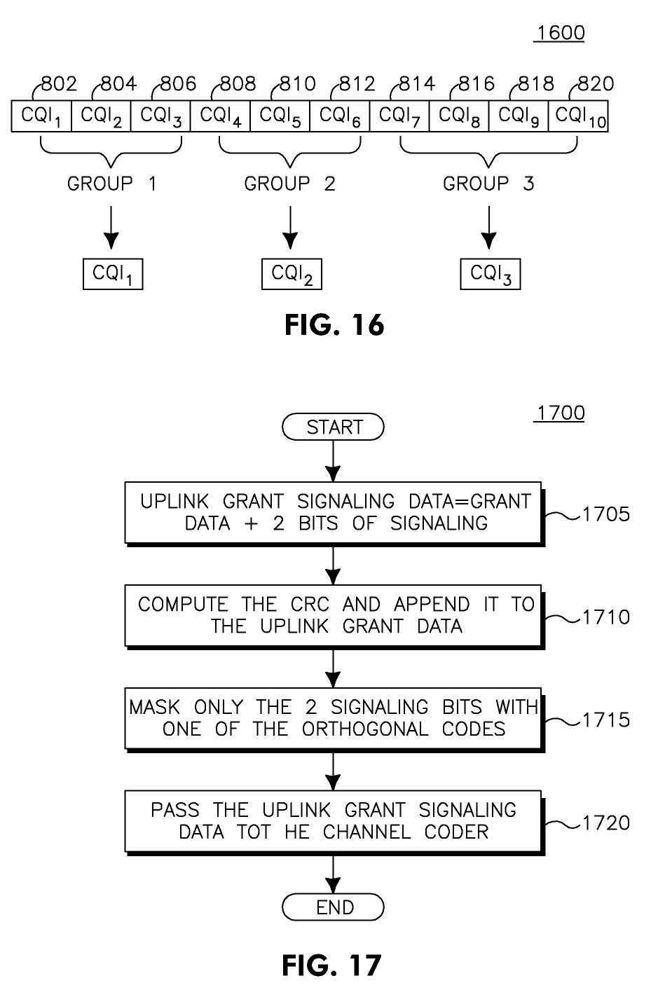

FIG. 16 shows different groups for periodic CQI reporting. For example, for the three groups shown in FIG. 16, the average CQI may be computed for each of these groups and the CQIs may be feedback at consecutive reporting instants. Note that different grouping rules may be used, for example, a simple rule is to divide odd and even numbered sub-bands into separate groups. This approach increases the CQI reporting accuracy of the full-sub-band feedback approach. The average CQIs of the different groups can also be differentially coded to reduce the feedback overhead. Note that, when the best-M approach is used, it is a special case of this general approach where there is only one group and that group consists of the best-M sub-bands. The same grouping idea can also be applied to the best-M approach where the M sub-bands can be divided into groups. However, because the best-M sub-bands change dynamically, it is necessary to keep them unchanged until all the feedback for all the groups is finished.

In another embodiment, a time differential CQI feedback technique may be used. The wideband CQI may be fed back, and the differential CQIs, (that represent the average CQI of that group), may be fed back during the same symbol with the wideband CQI or in consecutive symbols. The groups may be formed with some predetermined rules as explained in the previous sections. For example, if the total number of sub-bands is 10 and the group size is fixed to 3, the CQIs for the following groups may be reported at consecutive symbols: {Sub-bands 1, 2, 3}; {Sub-bands 4, 5, 6}; {Sub-bands 7, 8, 9}; {Sub-bands 10, 1, 1}, and the like. The reported group of sub-bands at different times may overlap to increase the CQI reporting accuracy.

Methods to Feedback Preceding Matrix Indicator (PMI) and Rank Information Feedback to a Node B

A method and apparatus is disclosed for a WTRU to feedback precoding matrix indicator (PMI), and rank information to a Node B with reduced overhead. When the Node B is equipped with multiple antennas, precoding may also be used to transmit multiple data streams to a WTRU. The WTRU has to feedback the precoding vector/matrix index and the rank to the Node B in addition to the CQI. The PMI and CQI may be transmitted by several different methods. In this embodiment, several methods to feedback the PMI and rank information are described.

Similar to the CQI, PMI can be the same for the whole bandwidth, called the wideband PMI, or can be different for each sub-band, called frequency selective PMI. When there is a PMI for each sub-band, then the feedback overhead needs to be reduced. For example, if the PMI index is represented with 4 bits for a system with 4 transmit antennas, then the feedback overhead for the PMI would be 4M, where M is the number of sub-bands.

The CQI and PMI can be fed back with completely independent mechanism. It is preferable, however to jointly feedback the two parameters for the following reasons: the CQI computation depends on the PMI that will be used for precoding at the Node B, (i.e., for a given CQI value, there is corresponding PMI index), for schemes where the indexes of the selected sub-band also must be fed back, such as the best-M method, coupling the CQI and PMI result in only one set of sub-band indexes to be fed back.

The differential CQI methods described in the previous sections to reduce the feedback overhead for the CQI feedback may also be used for PMI feedback. In this case, for example, the PMI of a sub-band can be computed differentially to a given reference point, (i.e. PMI sub-band=PMI reference+PMI A), where PMI A is the differential PMI and is represented with less than n bits, where n is the number of required bits for full-resolution PMI. For a given reference PMI, a set of PMIs are determined and this set is known the Node B and the WTRU. Then, each element in this set can be indexed with the bits that represent PMI Δ. Note that the number of bits required for wideband CQI and PMI, and differential CQI and PMI can be different.

The rank also needs to be fed back to the Node B, requiring up to 2 bits for four possible ranks. It is known that rank changes more slowly than the CQI and the PMI, so in a periodic reporting, the rank can be fed back less often than the CQI and PMI. In an a periodic reporting, the rank may be or may not be fed back with the CQI and PMI depending on the current rank information that is available at the Node B. If the information is current, then the rank does not need to be fed back; otherwise, the rank has to be fed back. Indicating the decision about whether rank is fed back in and a periodic report requires an additional 1 bit. If the 1 bit signaling is not used, then rank has to be fed back with the CQI and the PMI in and a periodic reporting because it may not always be possible to have an up-to-date rank information at the Node B.

Defining different reporting sizes and methods of handling these sizes

The possible reporting formats including CQI and PMI listed below would have different sizes. The method selected to compute the differential CQIs and PMIs also may change the sizes of the following formats:
1) No report;
2) Wideband CQI, wideband PMI;
3) Frequency selective CQI (full resolution), wideband PMI;
4) Frequency selective CQI (differential), wideband PMI;
5) Frequency selective PMI (full resolution), wideband CQI;
6) Frequency selective PMI (differential), wideband CQI;
7) Frequency selective CQI (full resolution), frequency selective PMI (full resolution);
8) Frequency selective CQI (differential), frequency selective PMI (full resolution);
9) Frequency selective CQI (differential), frequency selective PMI (differential); and
10) Frequency selective CQI (full resolution), frequency selective PMI (differential).

The reporting formats should be known to the Node B and the WTRU so that the Node B can correctly detect the CQI and PMI. There are two options to handle the coordination between the Node B and the WTRU about the format used. These are signaling of the reporting format or blindly detecting the reporting format.

When signaling is used to indicate the reporting format required by the Node B, either all of reporting format possibilities listed above or a selected subset of them need to be signaled. Signaling all of the ten possibilities listed above requires 4 bits. By selecting a subset which includes the most representative formats, the signaling overhead can be reduced. With 1 bit signaling, either a report or no report option may be selected.

When reporting is required, to indicate the format of the report, additional signaling is needed. Another method is to fix the reporting format semi-statically and use the same format until it is changed by the Node B.

With 2 bits of signaling, the following subset of combinations can be selected. Other possibilities include to report:
1) wideband CQI, wideband PMI;
2) frequency selective full resolution CQI, frequency selective full resolution PMI; and
3) frequency selective differential CQI, frequency selective differential PMI.

With 3 bits of signaling, eight of the reporting format possibilities listed above may be made available.

When signaling is not used and the reporting format is not fixed, then the Node B has to detect the format blindly. This procedure works as follows. The Node B demultiplexes the control information and the data in the PUSCH assuming that a reporting format has been used. After this, the data part is decoded and the cyclic redundancy check (CRC) is checked. If the CRC is correct, then the assumed reporting format is correct. If the control information is also protected with CRC, then the CRC of the control information can be used. By only using a subset of the possibilities, the number of blind detections can be reduced. For example, the subset of the four possibilities listed above can be used. It is also possible to select a subset of other possibilities.

A method that does not need signaling more than 1 bit (report or no report) or blind detection is to select a subset of the reporting format possibilities and implicitly indicate the reporting format used. For example, the WTRU can use one of the formats at a given time and hop through them in time either in a round robin fashion or with a pattern determined by the Node B.

As an example, if the second, third, and fourth options are selected to be used when reporting is required, then the following reporting patterns in time may be used:

2-3-4-2-3-4-2-3-4 . . . .

The same method may also be used with periodic reporting, but in this case, the 1 bit signaling that indicates a report is required is not necessary because the reporting instances are already known. As a special case, there may be only one reporting format. In this situation, only one reporting format may be used at all times.

Note that other subsets of reporting formats and repetition patterns are also possible. In this case, it is also possible not to transmit the wideband CQI and PMI together with the differential CQI and PMI if they were used as reference points to compute the differential CQI and PMI.

Method and Apparatus for Signaling Between the Node B and the WTRU to Coordinate the Feedback

A signaling method is disclosed herein that achieves L1 signaling of the required CQI format to the WTRU and solves the downlink ambiguity problem that causes errors in the ACK/NACK interpretation.

The downlink grant ambiguity happens because the WTRU does not know if there was a downlink grant which it was not able to decode or there was not a downlink grant in the first place. When the downlink grant control channel is successfully received, then the WTRU sends either an acknowledge (ACK) or a non-acknowledge (NACK) if the data channel can be decoded or not. If there was a downlink control channel and the WTRU was not able to receive the downlink grant control channel, then it sends a discontinuous transmission (DTX) (no signal) to the Node B.

If the WTRU misses the downlink grant and sends data instead of DTX, then the Node B may erroneously decode the data as an ACK or NACK. This problem can be solved in two ways. The resources for the ACK/NACK can be statically allocated and be never used for anything else except transmitting ACK, NACK, or DTX. This solution results in a waste of resources. The second is to include a 1 bit in the uplink grant which signals if there is downlink grant or not. If there is a downlink grant and it is missed, then the WTRU sends DTX. If there is not a downlink grant, then the WTRU sends data.

To signal the WTRU if the Node B requests a periodic CQI report or not, a 1 bit signaling has to be used in the uplink grant. With the 1 bit used to solve downlink grant ambiguity problem, there are 2 bits available for signaling. In this method, the 2 bits of resources (denoted as [x y]) show that there are other signaling possibilities for CQI format, such as, for example, reporting for frequency selective or frequency non-selective CQI.

As an example, the 2 bits may be used to signal these combinations:

1) No CQI report;

2) Wideband CQI report;

3) Frequency selective CQI (and PMI) report with full-resolution;

4) Differential frequency selective CQI (and PMI) report; or

5) Other combinations.

FIG. 17 is a flow chart illustrating exemplary adjustment of CQI and PMI signaling for a PUSCH that solves the downlink grant ambiguity. In step 1705, the downlink grant ambiguity is resolved by applying two orthogonal masks on 2 bits. For example, let us assume that the orthogonal masks are [1, 1] and [1, −1]. In step 1710, the original uplink grant data, with the 2 bits [x y], is used to compute the CRC. Then, in step 1715, after the CRC is computed, the 2 bits are masked with one of the masks (multiplied by the mask) depending on whether there is a downlink grant or not; the masks indicate if there is a downlink grant or not. Then, in step 1720, the resulting data is coded.

Generally, orthogonal masks over a number of bits in the data portion are used after the CRC is computed to send additional signaling data. The masks can be applied over a larger number of bits to increase the reliability. In the receiver, first the bits that are masked are de-masked by each of the masks and then the CRC is checked for the resulting data part. If the CRC is correct, then the signaling bits and the mask are recovered.

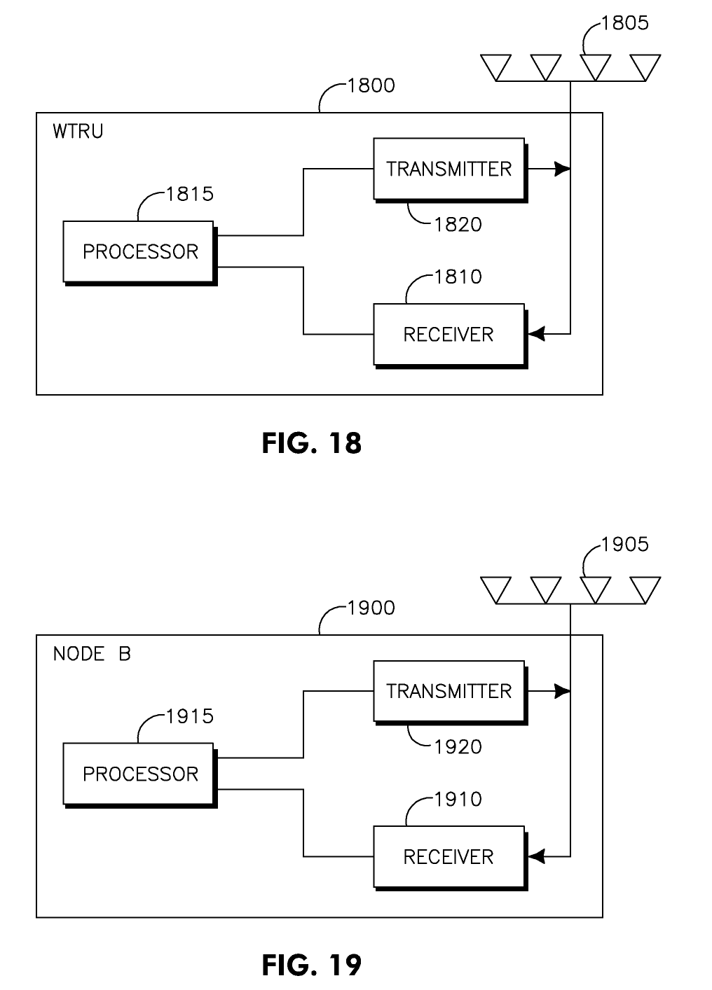

FIG. 18 is a functional block diagram of a WTRU 1800, which generates CQI information. In addition to the components that may be found in a typical WTRU, the WTRU 1800 includes a multiple input multiple output (MIMO) antenna 1805, a receiver 1810, a processor 1815 and a transmitter 1820. The receiver 1810 and the transmitter 1820 are in communication with the processor 1815. The MIMO antenna 1805 is in communication with both the receiver 1810 and the transmitter 1820 to facilitate the transmission and reception of wireless data.

Still referring to FIG. 18, the receiver 1810 receives signals and performs channel estimation. The estimated channel responses and the like are sent to processor 1815 for processing. The processor 1815 performs signal to interference plus noise power ratio (SINR) computation, CQI generation and/or PMI generation. The resulting CQI and/or PMI information is sent to transmitter 1820 for transmission of feedback signals via the MIMO antenna 1805.

In the WTRU 1800 of FIG. 18, the receiver 1810 may be configured to receive a contiguous set of frequency sub-bands of an OFDM symbol. The processor 1815 may be configured to denote a CQI value for each of the frequency sub-bands, wherein at least one particular one of the CQI values is computed differentially with respect to a CQI value denoted for a frequency sub-band that is adjacent to a frequency sub-band for which the particular CQU value is denoted. The transmitter 1820 may be configured to transmit the at least one differentially computed particular CQI value. The CQI value may be a full-resolution CQI value. The full-resolution CQI value may be represented with five bits.

In the WTRU 1800 of FIG. 18, the receiver 1810 may be configured to receive a contiguous set of frequency sub-bands of an OFDM symbol. The processor 1815 may be configured to denote a CQI value for each of the frequency sub-bands, wherein at least one particular one of the CQI values is computed differentially with respect to a CQI value denoted for a frequency sub-band that is adjacent to a frequency sub-band for which the particular CQU value is denoted. The transmitter 1820 may be configured to transmit the at least one differentially computed particular CQI value. The CQI value may be a full-resolution CQI value. The full-resolution CQI value may be represented with five bits.

The processor 1815 may also be configured to denote a CQI value for each of the frequency sub-bands, wherein at least one particular one of the CQI values is computed differentially with respect to a combination of CQI values. Thus, the transmitter 1820 may be configured to transmit the at least one differentially computed particular CQI value.

The processor 1815 may also be configured to compute an average wideband CQI for the frequency sub-bands, and denote a CQI value for each of the frequency sub-bands, wherein at least one particular one of the CQI values is computed differentially with respect to the average wideband CQI. Thus, the transmitter 1820 may be configured to transmit the at least one differentially computed particular CQI value.

The processor 1815 may also be configured to compute a full-resolution CQI for the frequency sub-bands, and denote a CQI value for each of the frequency sub-bands, wherein at least one particular one of the CQI values is computed differentially with respect to the full-resolution CQI. Thus, the transmitter 1820 may be configured to transmit the at least one differentially computed particular CQI value.

The processor 1815 may also be configured to determine an index of one of the frequency sub-bands having the largest CQI, and denote a CQI value for each of the frequency sub-bands, wherein at least one particular one of the CQI values is computed differentially with respect to the maximum CQI. Thus, the transmitter may be configured to transmit the at least one differentially computed particular CQI value and the index of the frequency sub-band having the maximum CQI.

In another scenario, the receiver 1810 may be configured to receive a non-continuous set of frequency sub-bands of an OFDM symbol. The processor 1815 may be configured to divide the non-continuous set of frequency sub-bands into a plurality of groups, determine the average CQI value of each group, and differentially compute the CQI values for the frequency sub-bands in a group with respect to the average CQI value of each group. The transmitter 1820 may be configured to transmit the average CQI values for each group and the differential CQI values for each of the frequency sub-bands. The processor 1815 may divide the non-continuous sub-bands into a plurality of groups by defining a group of sub-bands based on a maximum distance between indexes of any two sub-bands in a group, forming sub-bands into a group if a difference between indices of the sub-bands is below a given number, starting a first group with a frequency sub-band with the lowest index, adding sub-bands to the first group until there is no subcarrier suitable for the group, starting a second group, and adding subsequent sub-bands into the second group until all sub-bands are in a group.

In another scenario, the receiver 1810 may be configured to receive a first codeword and a second codeword. The processor 1815 may be configured to differentially compute a CQI value of the second codeword with respect to a CQI value of the first codeword, and the transmitter 1820 may be configured to transmit the CQI values periodically. The differential CQI of each sub-band for the second codeword may use the CQI of the same sub-band in the first codeword.

FIG. 19 is a functional block diagram of a Node B 1900. In addition to the components that may be found in a typical Node B, the Node B 1900 includes a MIMO antenna 1905, a receiver 1910, a processor 1915 and a transmitter 1920. The receiver 1910 and the transmitter 1920 are in communication with the processor 1915. The antenna 1905 is in communication with both the receiver 1910 and the transmitter 1920 to facilitate the transmission and reception of wireless data.

Still referring to FIG. 19, the receiver 1910 receives feedback signals, (i.e., CQI and/or PMI information), from the WTRU 1800, and decodes the feedback signals to obtain the CQI and/or PMI information. The processor 1915 processes the CQI and PMI information and produces corresponding modulation and coding schemes (MCS) according to the CQI(s) for data transmission. In addition, the processor 1915 produces a precoding matrix for precoding the data before transmission. After applying MCS and precoding to the data, the data is transmitted via the transmitter 1920 and MIMO antenna 1905.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of generating channel quality indicator (CQI) information, the method comprising:
receiving a contiguous set of frequency sub-bands of an orthogonal frequency division multiplex (OFDM) symbol;
denoting a CQI value for each of the frequency sub-bands, wherein at least one particular one of the CQI values is computed differentially with respect to a CQI value denoted for a frequency sub-band that is adjacent to a frequency sub-band for which the particular CQU value is denoted; and
reporting the at least one differentially computed particular CQI value.

2. The method of claim 1 wherein the CQI value is a full-resolution CQI value.

3. The method of claim 2 wherein the full-resolution CQI value is represented with five bits.

4. A method of generating channel quality indicator (CQI) information, the method comprising:
receiving a contiguous set of frequency sub-bands of an orthogonal frequency division multiplex (OFDM) symbol;
denoting a CQI value for each of the frequency sub-bands, wherein at least one particular one of the CQI values is computed differentially with respect to a combination of CQI values; and
reporting the at least one differentially computed particular CQI value.

5. The method of claim 4 wherein the CQI value is a full-resolution CQI value.

6. The method of claim 5 wherein the full-resolution CQI value is represented with five bits.

7. A method of generating channel quality indicator (CQI) information, the method comprising:
receiving a contiguous set of frequency sub-bands of an orthogonal frequency division multiplex (OFDM) symbol;
computing an average wideband CQI for the frequency sub-bands;
denoting a CQI value for each of the frequency sub-bands, wherein at least one particular one of the CQI values is computed differentially with respect to the average wideband CQI; and
reporting the at least one differentially computed particular CQI value.

8. The method of claim 7 wherein the CQI value is a full-resolution CQI value.

9. The method of claim 8 wherein the full-resolution CQI value is represented with five bits.

10. A method of generating channel quality indicator (CQI) information, the method comprising:
receiving a contiguous set of frequency sub-bands of an orthogonal frequency division multiplex (OFDM) symbol;
computing a full-resolution CQI for the frequency sub-bands;
denoting a CQI value for each of the frequency sub-bands, wherein at least one particular one of the CQI values is computed differentially with respect to the full-resolution CQI; and
reporting the at least one differentially computed particular CQI value.

11. A method of generating channel quality indicator (CQI) information, the method comprising:
receiving a contiguous set of frequency sub-bands of an orthogonal frequency division multiplex (OFDM) symbol;
determining an index of one of the frequency sub-bands having the largest CQI;
denoting a CQI value for each of the frequency sub-bands, wherein at least one particular one of the CQI values is computed differentially with respect to the maximum CQI; and
reporting the at least one differentially computed particular CQI value and the index of the frequency sub-band having the maximum CQI.

12. A method of generating channel quality indicator (CQI) information, the method comprising:
receiving a non-continuous set of frequency sub-bands of an orthogonal frequency division multiplex (OFDM) symbol;
dividing the non-continuous set of frequency sub-bands into a plurality of groups;
determining the average CQI value of each group;
differentially computing the CQI values for the frequency sub-bands in a group with respect to the average CQI value of each group; and
reporting the average CQI values for each group and the differential CQI values for each of the frequency sub-bands.

13. The method as in claim 12 wherein dividing the non-continuous sub-bands into a plurality of groups further comprises:
defining a group of sub-bands based on a maximum distance between indexes of any two sub-bands in a group;
forming sub-bands into a group if a difference between indices of the sub-bands is below a given number; and
starting a first group with a frequency sub-band with the lowest index;
adding sub-bands to the first group until there is no subcarrier suitable for the group;
starting a second group; and
adding subsequent sub-bands into the second group until all sub-bands are in a group.

14. A method of generating channel quality indicator (CQI) information, the method comprising:
receiving a first codeword and a second codeword;
differentially computing a CQI value of the second codeword with respect to a CQI value of the first codeword; and
reporting the CQI values periodically.

15. The method of claim 14 wherein the differential CQI of each sub-band for the second codeword uses the CQI of the same sub-band in the first codeword.

16. A wireless transmit/receive unit (WTRU) for generating channel quality indicator (CQI) information, the WTRU comprising:
a receiver configured to receive a contiguous set of frequency sub-bands of an orthogonal frequency division multiplex (OFDM) symbol;
a processor configured to denote a CQI value for each of the frequency sub-bands, wherein at least one particular one of the CQI values is computed differentially with respect to a CQI value denoted for a frequency sub-band that is adjacent to a frequency sub-band for which the particular CQU value is denoted; and
a transmitter configured to transmit the at least one differentially computed particular CQI value.

17. The WTRU of claim 16 wherein the CQI value is a full-resolution CQI value.

18. The WTRU of claim 17 wherein the full-resolution CQI value is represented with five bits.

19. A wireless transmit/receive unit (WTRU) for generating channel quality indicator (CQI) information, the WTRU comprising:
a receiver configured to receive a contiguous set of frequency sub-bands of an orthogonal frequency division multiplex (OFDM) symbol;
a processor configured to denote a CQI value for each of the frequency sub-bands, wherein at least one particular one of the CQI values is computed differentially with respect to a combination of CQI values; and
a transmitter configured to transmit the at least one differentially computed particular CQI value.

20. The WTRU of claim 19 wherein the CQI value is a full-resolution CQI value.

21. The WTRU of claim 20 wherein the full-resolution CQI value is represented with five bits.

22. A wireless transmit/receive unit (WTRU) for generating channel quality indicator (CQI) information, the WTRU comprising:
a receiver configured to receive a contiguous set of frequency sub-bands of an orthogonal frequency division multiplex (OFDM) symbol;
a processor configured to compute an average wideband CQI for the frequency sub-bands, and denote a CQI value for each of the frequency sub-bands, wherein at least one particular one of the CQI values is computed differentially with respect to the average wideband CQI; and
a transmitter configured to transmit the at least one differentially computed particular CQI value.

23. The WTRU of claim 22 wherein the CQI value is a full-resolution CQI value.

24. The WTRU of claim 23 wherein the full-resolution CQI value is represented with five bits.

25. A wireless transmit/receive unit (WTRU) for generating channel quality indicator (CQI) information, the WTRU comprising:
a receiver configured to receive a contiguous set of frequency sub-bands of an orthogonal frequency division multiplex (OFDM) symbol;
a processor configured to compute a full-resolution CQI for the frequency sub-bands, and denote a CQI value for each of the frequency sub-bands, wherein at least one particular one of the CQI values is computed differentially with respect to the full-resolution CQI; and
a transmitter configured to transmit the at least one differentially computed particular CQI value.

26. A wireless transmit/receive unit (WTRU) for generating channel quality indicator (CQI) information, the WTRU comprising:
a receiver configured to receive a contiguous set of frequency sub-bands of an orthogonal frequency division multiplex (OFDM) symbol;
a processor configured to determine an index of one of the frequency sub-bands having the largest CQI, and denote a CQI value for each of the frequency sub-bands, wherein at least one particular one of the CQI values is computed differentially with respect to the maximum CQI; and
a transmitter configured to transmit the at least one differentially computed particular CQI value and the index of the frequency sub-band having the maximum CQI.

27. A wireless transmit/receive unit (WTRU) for generating channel quality indicator (CQI) information, the WTRU comprising:
a receiver configured to receive a non-continuous set of frequency sub-bands of an orthogonal frequency division multiplex (OFDM) symbol;
a processor configured to divide the non-continuous set of frequency sub-bands into a plurality of groups, determine the average CQI value of each group, and differentially compute the CQI values for the frequency sub-bands in a group with respect to the average CQI value of each group; and
a transmitter configured to transmit the average CQI values for each group and the differential CQI values for each of the frequency sub-bands.

28. The WTRU of claim 27 wherein the processor divides the non-continuous sub-bands into a plurality of groups by defining a group of sub-bands based on a maximum distance between indexes of any two sub-bands in a group, forming sub-bands into a group if a difference between indices of the sub-bands is below a given number, starting a first group with a frequency sub-band with the lowest index, adding sub-bands to the first group until there is no subcarrier suitable for the group, starting a second group, and adding subsequent sub-bands into the second group until all sub-bands are in a group.

29. A wireless transmit/receive unit (WTRU) for generating channel quality indicator (CQI) information, the WTRU comprising:
a receiver configured to receive a first codeword and a second codeword;
a processor configured to differentially compute a CQI value of the second codeword with respect to a CQI value of the first codeword; and
a transmitter configured to transmit the CQI values periodically.

30. The WTRU of claim 29 wherein the differential CQI of each sub-band for the second codeword uses the CQI of the same sub-band in the first codeword.
